(19) United States
(12) Patent Application Publication
(10) Pub. No.: US 2024/0129601 A1
(43) Pub. Date: Apr. 18, 2024

(54) CONTENT VELOCITY AND HYPER-PERSONALIZATION USING GENERATIVE AI

(71) Applicant: Adobe Inc., San Jose, CA (US)

(72) Inventors: Oliver BRDICZKA, San Jose, CA (US); Kaushal KANTAWALA, San Jose, CA (US); Ion ROSCA, San Jose, CA (US); Aliakbar DARABI, San Jose, CA (US); Alexandru Vasile COSTIN, San Jose, CA (US); Alexandru CHICULITA, San Jose, CA (US)

(21) Appl. No.: 18/306,048

(22) Filed: Apr. 24, 2023

Related U.S. Application Data
(60) Provisional application No. 63/416,874, filed on Oct. 17, 2022.

(51) Int. Cl. H04N 21/854; H04L 67/306

(52) U.S. Cl. CPC H04N 21/854; H04L 67/306

(57) ABSTRACT

A method includes receiving a description of content to be generated using a generative model. The received description of content is associated with a user profile. The method further includes determining a semantic term based on the description of content. The method further includes generating a user-specific template including the semantic term and a user preference associated with the user profile. The method further includes generating the content using the generative model based on the user-specific template. The method further includes outputting the content for display on a target user device.

### CROSS-REFERENCE TO RELATED APPLICATIONS

This application claims the benefit of U.S. Provisional Application No. 63/416,874, filed Oct. 17, 2022, which is hereby incorporated by reference.

### BACKGROUND

Scaling personalized content is stunted by the speed of content production. Producing high quality content that is personalized for a target audience requires manual, repetitive, and labor-intensive processes. Target audiences include, but are not limited to, age groups, geographic groups, and individual users.

### SUMMARY

Introduced here are techniques/technologies that produce personalized content for a target audience. A personalized content recommendation system leverages natural language processing, personalization techniques, and generative AI to generate content at scale. Generating such large scale content enables designers to produce content that is hyper-personalized to different audiences and purposes.

More specifically, in one or more embodiments, the personalized content recommendation system decomposes intents/titles (or other received descriptions of content to be generated) into personalization variables. Meta-templates are employed by the personalized content recommendation system to recommend content at scale, where meta-templates include personalization variables, control loops, and sub-prompts that drive one or more generative AI algorithms. A sub-prompt, as described herein, may include a free text description (e.g., a preamble) and one or more personalization variables derived from the inputs. Using the meta-template, a user (such as a designer or other content producer) navigates the space of multi-level semantic representations to refine a composite of images generated from the sub-prompts. In particular, the user may refine personalization variables (e.g., colors to be used in the content, a general mood of the content, etc.) extracted from the decomposed intent/title and provide such refinements as a variable into a sub-prompt.

Using the meta-template, a user (such as a designer or other content producer) may personalize content for a consumer (a user consuming the generated content) by leveraging consumer profiles. In this manner, content is created by the personalized content recommendation system that aligns with the intent of a user (such as a designer) but dynamically serves personalized content to a consumer. In some embodiments, layers within the meta-template (or sub-prompts) may be used as a search term for repositories of consumer or marketplace content.

In some embodiments, the meta-templates are personalized with respect to a given user (such as a designer) and/or groups of users/consumers (e.g., groups of users/consumers the same age, groups of users/consumers in the same/similar geographic location, groups of users/consumers providing content (or consuming content) in the same/similar industry/domain). For example, the personalized content recommendation system may leverage collaborative filtering or other personalization techniques to determine sub-prompts of a meta-template with respect to a particular user (or group of users).

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of producing personalized content for a target audience, in accordance with one or more embodiments;

FIG. 2 illustrates a meta-template, in accordance with one or more embodiments;

FIG. 3 illustrates an image generated using the personalized content recommendation system, in accordance with one or more embodiments;

FIG. 4 illustrates another meta-template, in accordance with one or more embodiments;

FIG. 5 illustrates a batch of images generated using the personalized content recommendation system, in accordance with one or more embodiments;

FIG. 6 illustrates an example of generated content, in accordance with one or more embodiments;

FIG. 7 illustrates an example implementation of a diffusion model, in accordance with one or more embodiments;

FIG. 8 illustrates the diffusion processes used to train the diffusion model, in accordance with one or more embodiments;

FIG. 9 illustrates a schematic diagram of a personalized content recommendation system in accordance with one or more embodiments;

FIG. 10 illustrates a flowchart of a series of acts in a method of producing personalized content for a target audience in accordance with one or more embodiments; and

FIG. 11 illustrates a block diagram of an exemplary computing device in accordance with one or more embodiments.

### DETAILED DESCRIPTION

One or more embodiments of the present disclosure include a personalized content recommendation system that produces content that is personalized (or hyper-personalized) to different audiences and purposes. One conventional approach involves manually creating each individual content piece and adapting the content to an audience or purpose in a campaign. Such processes limit content production velocity. Other conventional approaches automatically duplicate certain content. However, these approaches still limit content production velocity as one or more users tune the duplicated content by replacing different images, fonts, and/or colors, reorganizing the content, and the like. Yet other conventional approaches automatically generate images from a description. However, these approaches limit control and customization over the generation process for content at scale. For example, these conventional approaches may produce varying quality content, but a user has little or no control to edit large-scale generation of such content.

To address these and other deficiencies in conventional systems, the personalized content recommendation system of the present disclosure combines natural language processing, generative AI, and personalization techniques to produce personalized content to different audiences, where an audience may be a group of consumers in an age group, a group of consumers in a geographic location, a group of consumers with similar hobbies, a single user, a group of consumers of the same sex, and the like. At any point, a user (such as a designer) can edit a personalization variable, resulting in a new personalized content recommendation.

Allowing a user to generate content at scale reduces computing resources (e.g., power, memory, bandwidth, etc.) spent tuning or otherwise adapting visual elements of content for a target audience. Moreover, enabling a user to edit the generated content reduces computing resources associated with executing a system multiple times. For example, before a user executes the personalized content recommendation system, the user may make any one or more refinements to sub-prompts determined using extracted personalization variables from a user input. The refinements limit the amount of wasted computing resources by allowing the user to make such refinements before the personalized content recommendation system is executed, as opposed to executing a recommendation system and re-executing the recommendation system after refining one or more parameters.

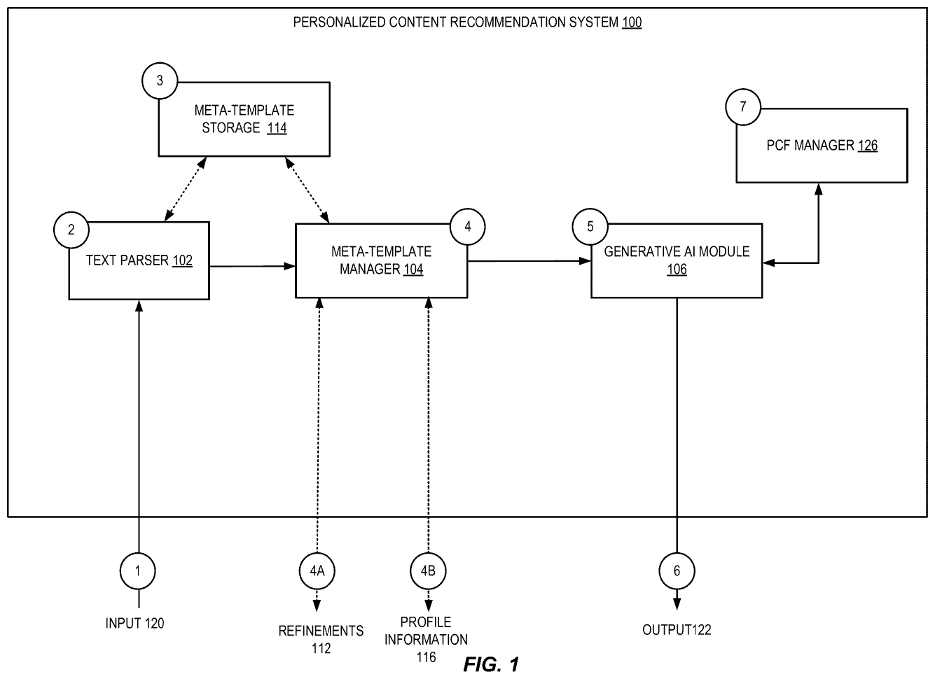

FIG. 1 illustrates a diagram of a process of producing personalized content for a target audience, in accordance with one or more embodiments. As shown in FIG. 1, embodiments include a content recommendation system 100. The content recommendation system 100 includes a text parser 102, a meta-template manager 104, a generative AI module 106, a PCF manager 126, and a meta-template storage 114. The content recommendation system 100 is responsible for generating content at scale.

At numeral 1, the content recommendation system 100 receives an input 120. The input 120 is a title of the content, a purpose of the content, a user intent, or some description of content to be generated (e.g., consumable content). The input 120 may be received in the form of a text input, a selection from a dropdown menu, an audio-to-text transcription, and the like. As described herein, the input 120 may be appended with user identification information such that the meta-template manager 104 (described herein) can map the user identification information to a user profile.

At numeral 2, the text parser 102 parses or otherwise decomposes the input 120 into one or more personalization variables. Such personalization variables may be semantically related blocks determined from the input 120. A semantic block is a semantically related phrase, term, and the like, derived from the input 120 that may be stored as a personalization variable for future use.

In some embodiments, the text parser 102 expands the semantic blocks derived from the input 120 using natural language processing techniques. For example, the text parser 102 parses the input 120 using any suitable parsing technique such as sentence tokenizers. Subsequently, the text parser 102 performs any suitable semantic searching/semantic relatedness technique to derive personalization variables from the parsed input 120. For example, geo-location, landmark, style, mood, personites, color, and the like, may all be semantic personalization variables derived from the input 120 using any suitable semantic searching/semantic relatedness technique.

In a particular example, the text parser 102 extracts a location personalization variable from the input 120. For instance, the text parser 102 may leverage any one or more part of speech tagging and entity extraction algorithms. In a different example, the text parser 102 extracts a landmark personalization variable using a list of predetermined locations and any one or more previously extracted personalization variable. For instance, the text parser 102 may leverage a language transformer model such as GPT-3 to generate/isolate the most appropriate landmarks for a location listed in the list of predetermined locations.

In some embodiments, the text parser 102 further enhances the set of landmarks using vectors of a large word2vec model. Specifically, the word2vec vectors include vector representations of landmarks and corresponding geographic locations. Characterizing such relationships of landmarks and geographic locations results in identifying semantically related categories in an input. For example, personites, geolocations, landmarks and the like are all semantically related personalization variables extracted by the text parser 102. A personite refers to people from a location. For instance, “Germans” from Germany, “Parisians” from Paris, etc.

In yet a different example, the text parser 102 extracts one or more mood or topic personalization variables using a zero-shot classification transformer model such as BART, operating on a restricted mood dictionary. In another example, the text parser 102 extracts color as a personalization variable using any suitable mechanism. For example, in one implementation, one or more word2vec vectors can provide an initial list of colors related to the input 120 using vector similarity run on all the nouns in the input 120 (e.g., extracted through part of speech (POS) tags, POS tags NN, NNP, and the like). In another implementation, colors may be extracted by the text parser 102 as a personalization variable using generative AI. For example, the generative AI is used to generate a small image from the input 120. Subsequently, the text parser 102 extracts dominant colors from the image.

In some embodiments, the personalization variables extracted from the input is dependent on a meta-template storage 114. At numeral 3, the meta-template storage 114 prompts the text parser 102 to extract certain personalization variables from the input. As described herein, the meta-template storage 114 stores template information such as personalization variables, refinements 112, profile information 116, sub-prompts, and the like. The meta-template storage 114 may be a storage repository (e.g., server, database, etc.) hosted by the personalized content recommendation system 100, hosted by one or more external systems, or some combination (e.g., a cloud storage system). The meta-template storage 114 can direct the text parser 102 to extract personalization variables corresponding to a particular user and/or corporation (e.g., profile information 116) by storing information corresponding to the particular user and/or corporation. As described herein, profile information 116 includes both profiles of end users (e.g., designers, corporations, etc.) and consumer users (e.g., target consumers). Depending on the profile information 116, different personalization variables are extracted from the input. For example, the meta-template storage 114 may correlate a user and/or corporation with a particular meta-template using profile information 116 such as a user identifier, corporation identifier, and the like. In some embodiments, the profile information 116 is appended to the input 120. As described herein, the meta-template is a user-specific template populated with personalization variables and corresponding sub-prompts extracted from input 120.

At numeral 4, the personalization variables extracted from the input are fed to the meta-template manager 104. The meta-template manager 104 organizes a template to be displayed to an end user (a designer or other content producer). The template is a compilation of sub-prompts, which may be manually determined and/or automatically determined. A sub-prompt, as described herein, may include a free text description provided by a user and/or one or more personalization variables derived from the input 120. Additionally or alternatively, the sub-prompt may be a portion of the input 120. In some implementations, the operations of the meta-template manager 104 are the same or similar to those of the PCF manager 126 described herein.

In some embodiments the meta-template manager 104 queries the meta-template storage 114 at numeral 3 for a meta-template associated with an end user profile (as opposed to a target consumer user profile). Using the user profile information 116, the meta-template manager 104 populates a meta-template with user preferences. Meta-templates associated with different users (such as designers), corporations, entities, etc. are stored in the meta-template storage 114. As described herein, the meta-template manager 104 determines a meta-template associated with a user profile responsive to an identifier associated with the user. An identifier such as a user number, user name, email address, phone number, etc. may be appended to input 120, associated with input 120 metadata, and the like. Meta-templates may vary, for example, by the sub-prompts associated with user profiles identified via profile information 116. Moreover, meta-templates may vary depending on one or more control loops and/or constraints. Such control loops/constraints may refine the use of personalization variables in the meta-template. For example, a constraint may specify a particular subset of personalization variables for use in a particular meta-template. For instance, a user preference (obtained via profile information 116) may exclude the <mood> personalization variable from a meta-template. Accordingly, the meta-template manager 104 does not prompt the text parser for the <mood> personalization variable extracted from input 120.

At numeral 4A, the meta-template manager 104 displays a meta-template to the user and receives one or more user refinements 112 determined by an end user (e.g., a content designer). A user refinement 112 is a modification to a semantic block determined by the text parser 102, an addition of a one or more sub-prompts in the meta-template, a deletion of one or more sub-prompts in the meta-template, a modification of a sub-prompt in the meta-template, a modified intent (e.g., a new input 120), a modified control loop and/or constraint, an addition of a control loop and/or constraint, a removal of a control loop and/or constraint, and the like. For example, a user may navigate the space of the personalization variables in the displayed meta-template as a multi-level semantic representation. Providing the user access to the personalization variables refines the composite of images generated from the sub-prompts. For instance, a user may choose between colors or moods that have been extracted for insertion into the sub-prompt. Additionally or alternatively, a user may further define semantic and/or design rules in the prompt domain specific language to configure contrasting colors, make decisions about specific conditions in the personalization variables, and the like. The user refinements 112 operate on the personalization variables and raw prompts fed to the generative AI module 106.

At numeral 4B, the meta-template manager 104 displays a meta-template to the user and receives profile information 116. As described herein, profile information 116 is any information specific to a consumer user (e.g., a target user) and/or an end-user (e.g., a designer). For example, profile information 116 associated with a consumer user may include a geographic location, a name, a favorite color, a career, a type of computing device, musical preferences, and the like. The meta-template manager 104 incorporates the profile information 116 into sub-prompts. The more information provided to the generative AI module 106 (in the form of a prompt based on the meta-template sub-prompts), the more personalized and specific the generated content produced by the generative AI module will be. In this manner, personalized content corresponding to an intent of an end user (a designer) with respect to a specific consumer user based on profile information is generated. For example, the end user (e.g., a content producer) determines a preferred style of content to be displayed to a customer, where the content itself is based on the customer.

In some embodiments, an end user (such as a designer) inputs profile information 116 (e.g., consumer information) to hyper-personalize content determined by the personalized content recommendation system 100. In other embodiments, the meta-template manager 104 queries one or more servers, applications, databases, and the like for profile information 116. In these embodiments, the meta-template manager 104 populates sub-prompts with the received profile information. In yet other embodiments, the user inputs profile information as part of input 120. In these embodiments, the text parser 102 extracts profile information such that the extracted profile information can be populated into sub-prompts.

At numeral 5, the user-specific template populated with personalization variables and corresponding sub-prompts (e.g., the meta-template) is fed into one or more generative AI modules 106. The generative AI module 106 generates content (e.g., an image) to be consumed by a consumer (or a target user). The generative AI module 106 may be any generative AI module configured to generate content using a prompt. In some embodiments, the generated content includes text. As described herein, the prompt is the meta-template including multiple sub-prompts and corresponding personalized variables. The personalization variables are used in the prompts for the generative AI module 106 where sub-layers of a larger composite document are configured using a domain specific language (DSL) that include both variable replacement and basic control loops (e.g., if/else statements, for each statements, etc.).

As part of the content generation process performed by the generative AI module 106, the generative AI module 106 uses a seed. In some embodiments, the generative AI module 106 creates the seed. The seed is an initialization state for a deterministic process such as generating an image by the generative AI module 106. Specifically, the seed includes any configuration settings of one or more machines (or one or more virtual machines) executing the generative AI module 106. For example, configuration settings can include the time that the generative AI module 106 is being executed to generate the content. Additionally or alternatively, the seed can include the initialized noise that is denoised to generate the content according to the template.

The generative AI module 106 may be any artificial intelligence including one or more neural networks. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In some embodiments, one or more generated layers of the generative AI module 106 can be used as a search term for repositories of user or marketplace content. For example, once a particular image is generated for a beach in a geographic location, the generated image may be used to search one or more databases for actual beaches in the geographic image with the same or similar composition, color palette, negative space, etc. That is, the content determined by the generative AI module can be used to query semantically related images. As a result, the content output from the personalized content recommendation system 100 may be obtained using the received semantically related images.

At numeral 6, content is output from the personalized content recommendation system 100 as output 122. Such content may be communicated to one or more computing devices (e.g., a device of a target user), downstream processers (for subsequent processing), and the like.

At numeral 7, a personalized creative file format (PCF) manager 126 aggregates extracted one or more of the input 120, the extracted personalization variables (e.g., from the text parser 102), refined personalized variables (e.g., received from refinements 112), generated sub-prompts in the meta-template, refined sub-prompts in the meta-template (e.g., received from refinements 112), control loops, constraints, rules, and output 122 to create a PCF document (otherwise referred to herein as a PCF file). The PCF document may be stored in a data store (e.g., a database, a server, a cloud hosted by one or more servers, etc.). As described herein, the PCF manager 126 persists (or otherwise stores) information of the personalized content recommendation system 100 pipeline in the PCF document. The personalized content recommendation system 100 pipeline refers to the modules (e.g., text parser 102, meta-template storage 114, meta-template manager 104, and generative AI module 106) of the personalized content recommendation system 100 and the corresponding data associated with each module, resulting in a particular output 122.

In some embodiments, information persisted in the PCF document includes s the generative AI module 106, the seed used in the generative AI module 106, one or more algorithms/techniques to adapt to any signal like text, language, product insertion or artistic change, and the like. By storing such data, the PCF document preserves the original design or commercial intent. Specifically, by storing the seed of the generative AI modules, the randomness of each of the generative AI modules becomes predictable or otherwise able to be replicated. In some embodiments, the noise used in a diffusion process performed by the generative AI module 106 is also stored in the PCF document.

In some embodiments, other information associated with a particular consumer consuming content (e.g., profile information) is aggregated and stored in the PCF document. By including profile information in the PCF document, the personalized content recommendation system 100 is able to generate hyper-personalized content matching the intent of a user (such as a content producer) and dynamically serve personalized content to a particular consumer (e.g., a target user).

In some embodiments, the PCF manager 126 personalizes PCF documents with respect to a particular user (a designer or content creator). For example, the PCF manager 126 may personalize the display of the PCF document (e.g., an actual navigation within the PCF document) based on a stateful representation of a user's previous choices from the multi-level semantic representation (for previous sub prompts). For example, the PCF manager 126 may employ collaborative filtering, where one or more algorithms are utilized to filter data from users to make personalized recommendations for users with similar preferences (e.g., inter-user personalization). For example, the PCF manager 126 may create a meta-template with populated preferences based on a group of users similar to a target user and their corresponding preferences. Similar users may be users in the same geographic location, users employed by the same corporation/entity, users of the same sex, users of the same age, etc.

Other personalization techniques may be executed by the PCF manager 126 (e.g., identifying ‘recent’ user preferences) to personalize the PCF document for specific users (e.g., intra-user personalization). For example, the PCF manager 126 may store a user's edit history (e.g., refinements to sub-prompts, controls, etc.) as a user-specific preference. Additionally or alternatively, the PCF manager 126 stores specific user preferences associated with sub-prompts.

To enable the user personalization, the PCF manager 126 may save the history of personalized variables in the PCF documented in order to be able to restore previous states or navigate between states.

In a first non-limiting example, during a first period in time, a user indicates preferences for “cheerful” designs with red/orange color tones. During a second period of time, (e.g., when the personalized content recommendation system 100 is being executed to create consumable content), the PCF manager 126 presets (or otherwise populates) such user preferences in the meta-template. For example, the user preferences may be default (or preferred) when the meta-template is displayed to the user. In this manner, the PCF manager 126 persists learned user preferences, profile information, templates, semantically related terms extracted from an input, generative AI module 106 parameters, and the like.

In a second non-limiting example, a user may work in a particular domain (e.g., travel). As such, the PCF manager 126 populates a template with sub-prompts associated with travel. For example, sub-prompts may be directed to geographic location, landmarks, and the like.

If a user makes any refinements to any information stored in the file (e.g., a semantically related term to a description of content, user preferences, etc.), the PCF manager 126 may update the file to include such refinements. In some embodiments, the PCF manager 126 overrides any existing information in the file that has been refined. In other embodiments, the PCF manager 126 makes a new file including such refinements. In yet other embodiments, the PCF manager 126 stores such refinements as part of a user edit history in the file.

By persisting the personalized content recommendation system 100 pipeline, the PCF manager tracks content output at output 122. In some embodiments, the PCF manager 126 compares a current pipeline, or information obtained from the personalized content recommendation system 100 pipeline (e.g., input 120, the generative AI module 106, the seed of the generative AI module 106, the template populated by the meta-template manager 104, etc.) to one or more stored PCF documents. For example, the PCF manager 126 may compare the current pipeline to a number of recently stored PCF files, a number of stored PCF files associated with a user, etc. Specifically, the PCF manager 126 may compare the seed of the generative AI module 106, the template populated by the meta-template manager 104, and the like, of the current pipeline to a pipeline of a stored PCF file.

By comparing information of the current pipeline to one or more PCF files, the PCF manager 126 determines whether the current pipeline is similar or dissimilar. For example, if information of the current pipeline compared to a most recent PCF file is different by a threshold amount (e.g., a threshold number of information fields, where an information field corresponds to information of the PCF file), then the PCF manager 126 determines that the current pipeline is different from one or more stored PCF files. By determining that the current pipeline is different, the PCF manager 126 ensures that each output 122 is different from previously output content.

Alternatively, if information of the current pipeline compared to the most recent PCF file is similar by a threshold amount, then the PCF manager 126 determines that the current pipeline is the same or similar to one or more stored PCF files. By determining that the current pipeline is similar, the PCF manager 126 ensures that the output 122 is consistent to previously output content.

In some embodiments, the PCF manager 126 ensures that the current pipeline is similar to or the same as a stored PCF file. For example, the PCF manager 126 populates a template of the current pipeline with information obtained at a second period of time after a first period of time, where, during the first period of time, profile information was obtained, a user made a refinement, semantically related personalization variables were extracted from an input 120, etc. In a first non-limiting example, by populating a current pipeline with information of a PCF file, a user may refine a previously stored personalized content recommendation system 100 pipeline. For instance, a user may pick-up creating personalized content after a break. In a second non-limiting example, by populating a current timeline with information of a PCF file, a user may provide fewer refinements to the personalized content recommendation system 100 as the previously generated and user-approved output will be similarly produced by the personalized content recommendation system 100. For example, a user may have previously tuned a meta-template and therefore does not need to re-tune the persisted meta-template.

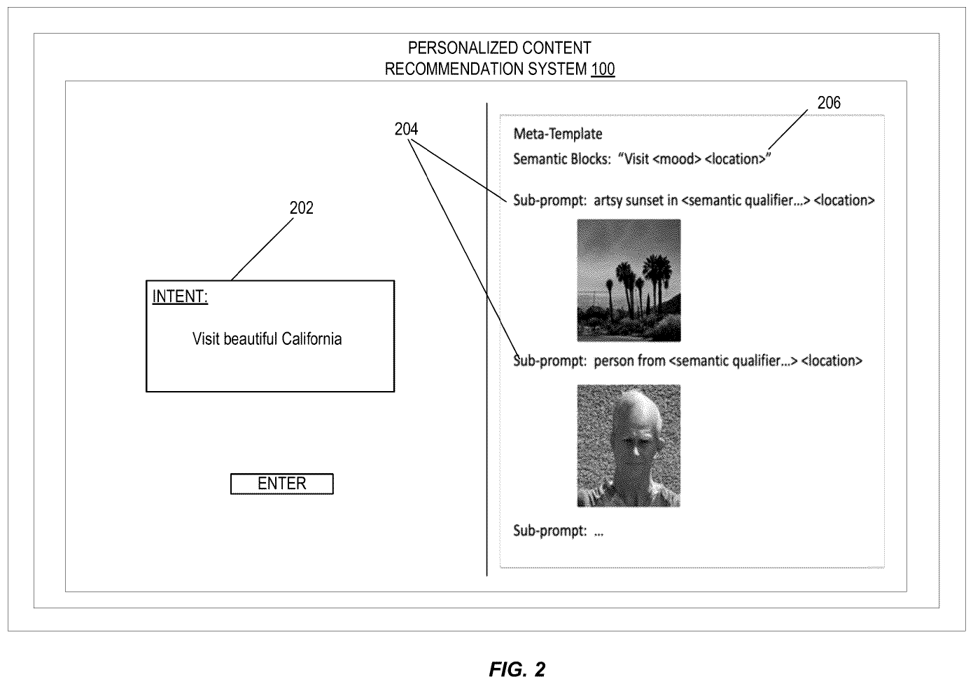

FIG. 2 illustrates a meta-template, in accordance with one or more embodiments. As shown, a user may enter an input 202. As shown, the input may be received by the personalized content recommendation system 100 as free text in a text box. Responsive to the input 202, the personalized content recommendation system 100 generates and displays the meta-template, which is specific to the end user entering input 202. As described herein, the meta-template may be pre-populated with sub-prompts (e.g., sub-prompts 204) based on one or more user preferences, corporation preferences (e.g., a corporation associated with the user such as an employer), control loops, constraints, and the like. As shown, sub-prompts 204 describe “artsy subset in <semantic qualifier> <location>” and “person from <semantic qualifier> <location>.” As described herein, the information extracted from the input 202 becomes a personalization variable used to complete the sub-prompts. Specifically, semantically related personalization variables extracted from the input 202 are the semantic blocks <mood> and <location> indicated at 206. If a personalization variable is not extracted from the input, in some embodiments, one or more default user preferences are used to populate the meta-template. As described herein, the personalization variables are semantically related phrases, terms, etc. (otherwise referred to herein as semantic blocks).

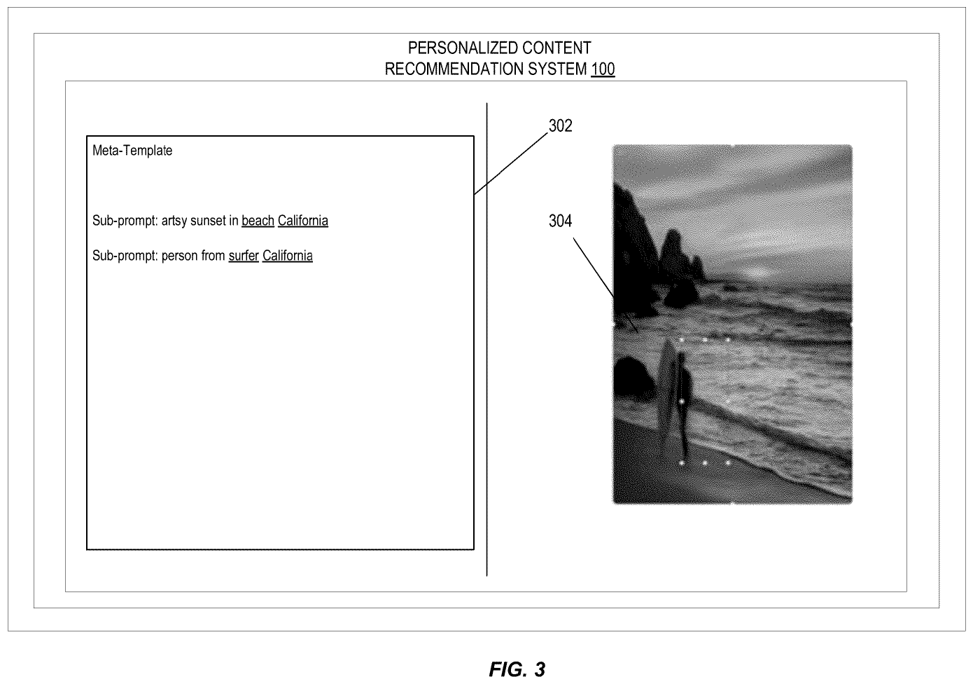

FIG. 3 illustrates an image generated using the personalized content recommendation system 100, in accordance with one or more embodiments. As shown, the meta-template 302 is populated with personalization variables extracted from the input 202. In the example of FIG. 2, the tags <semantic qualifier> and <location> refer to one or more editable lists of the personalization variables extracted from the input 202. As shown in the meta-template 302, such personalization variables have been determined. Specifically, the sunset is at a beach, and the person is a surfer. The user intent “visit beautiful California” (described in input 202 in FIG. 2) is visualized in image 304 using semantically related phrases associated with a person from California (e.g., a surfer) and a semantically related phrase associated with a location of a sunset in California (e.g., a beach).

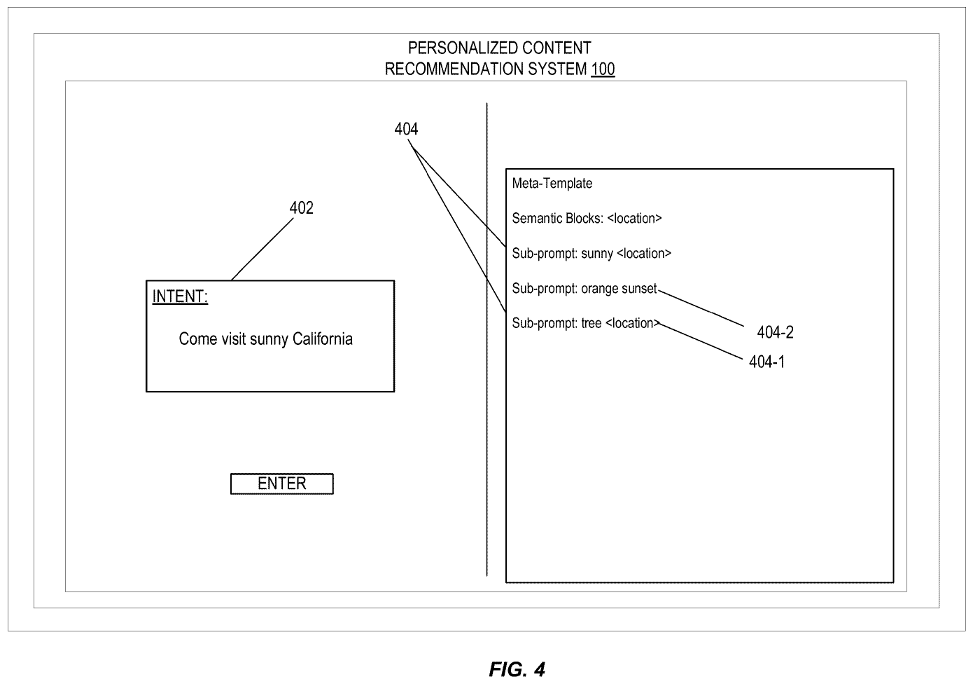

FIG. 4 illustrates another meta-template, in accordance with one or more embodiments. As shown, a user may enter an input 402 in a free text box. Responsive to the input 402, the personalized content recommendation system 100 generates and displays the meta-template. As described herein, the meta-template may be pre-populated with sub-prompts (e.g., sub-prompts 404) based on profile information such as user preferences, corporation preferences, control loops, constraints, and the like. For example, a user may have modified the template to include a user preference indicated at 404-1. Specifically, the user preference is a creation of a tree associated with a geographic location. As described herein, the information extracted from the input 402 by the text parser 102 becomes a personalization variable used to complete one or more sub-prompts. As shown, the meta-template includes another user preference 404-2 that is independent from the input 402 or any semantically derived personalization variables.

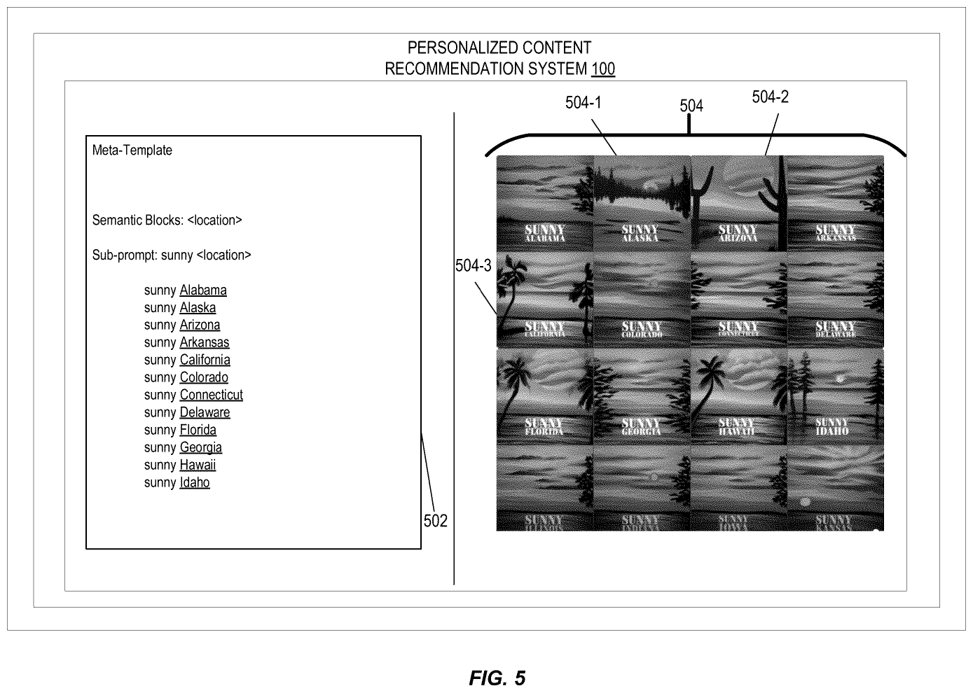

FIG. 5 illustrates a batch of images generated using the personalized content recommendation system 100, in accordance with one or more embodiments. As shown, the meta-template 502 is populated with personalization variables extracted from the input 402. Specifically, the text parser 102 extracts a state as a <location> personalization variable based on the input “California” received in input 402. As shown, only a subset of states (e.g., Alabama, Alaska, Arkansas, California, Colorado, Connecticut, Delaware, Florida, Georgia, Hawaii, Idaho) are selected from all of the states. That means, a constraint (not shown) was used by the meta-template manager 104 to constrain all of the states to the identified set of states. In this manner, content is only produced according to the set of states identified in the constraint.

As shown, from a single input (e.g., input 402), a large scale batch of personalized content 504 is created. The generated content 504 is personalized according to each sub-prompt. For example, as shown, each generated content illustrates a unique geographic location and faithfully portrays description from each of the sub-prompts of the meta-template. For example, the user preference to create a tree corresponding to a particular geographic location (e.g., indicated at sub-prompt 404-1 in FIG. 4) is illustrated in the batch of generated content 504. As illustrated, pine trees populate the “Sunny Alaska” campaign 504-1, cacti populate the “Sunny Arizona” campaign 504-2, and palm trees populate the “Sunny California” campaign 504-3. Moreover, the user preference to illustrate an orange sunset (e.g., indicated by user preference 404-2 in FIG. 4) is shown in all of the generated content 504.

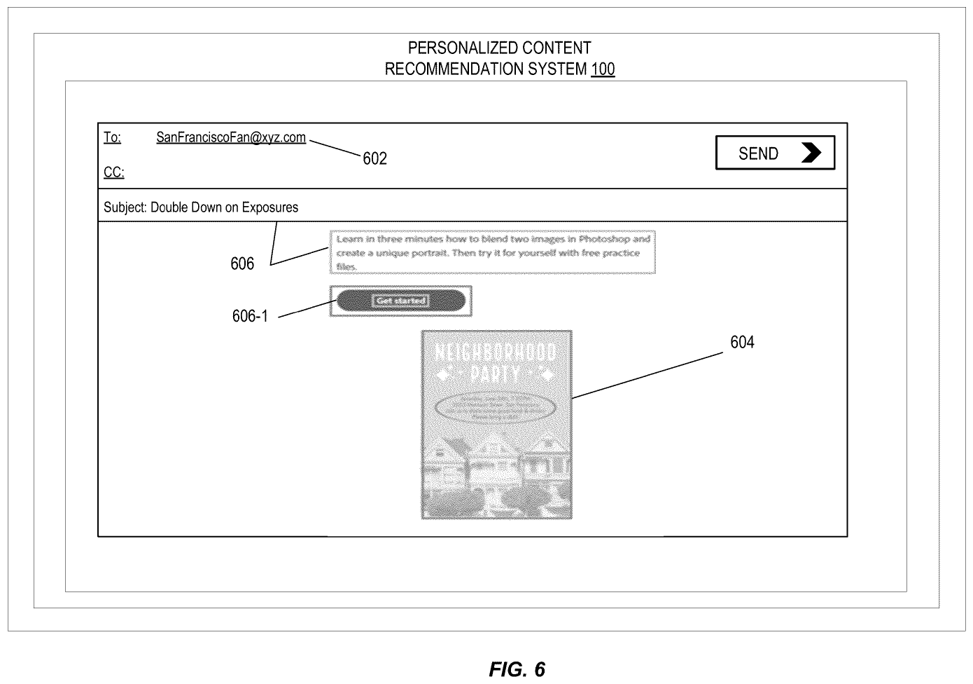

FIG. 6 illustrates an example of generated content, in accordance with one or more embodiments. In particular, FIG. 6 illustrates content that has been generated in an email to be distributed in an email application. While an email is shown and an email application is described, the personalized recommendation system 100 may interface with other one or more applications and provide content to other applications.

The generated content may be sourced from a PCF document adapted to a specific user profile. As shown, profile information (e.g., consumer information) is extracted from the PCF file in the form of a particular user email address at 602. Using such profile information, the personalized content recommendation system generates content that may be of interest to the user (e.g., the consumer/target user). For example, the target user may live in San Francisco or otherwise be a fan of San Francisco, as evidenced by the email address “SanFranciscoFan.” As a result, the personalized content recommendation system 100 generates an email using a generated neighborhood in San Francisco at 604.

Specifically, the content at 604 describes a “neighborhood party.” Such content may be based on one or more personalization variables. In the specific example of FIG. 6, the personalized content recommendation system may generate a “neighborhood party” as a result of a <seasonal> personalization variable. For instance, neighborhood parties may be semantically associated with a particular season in San Francisco.

As indicated by 606, text content may be generated by the personalized content recommendation system. Such content may be editable by an end user (e.g., a content producer). In some embodiments, as shown by 606-1, some content generated by the personalized content recommendation system 100 is interactive. That is, the personalized content recommendation system 100 may link content to one or more applications, URLs, and the like. The user may reconfigure the linked content, the interactive button corresponding to the linked content, and the like.

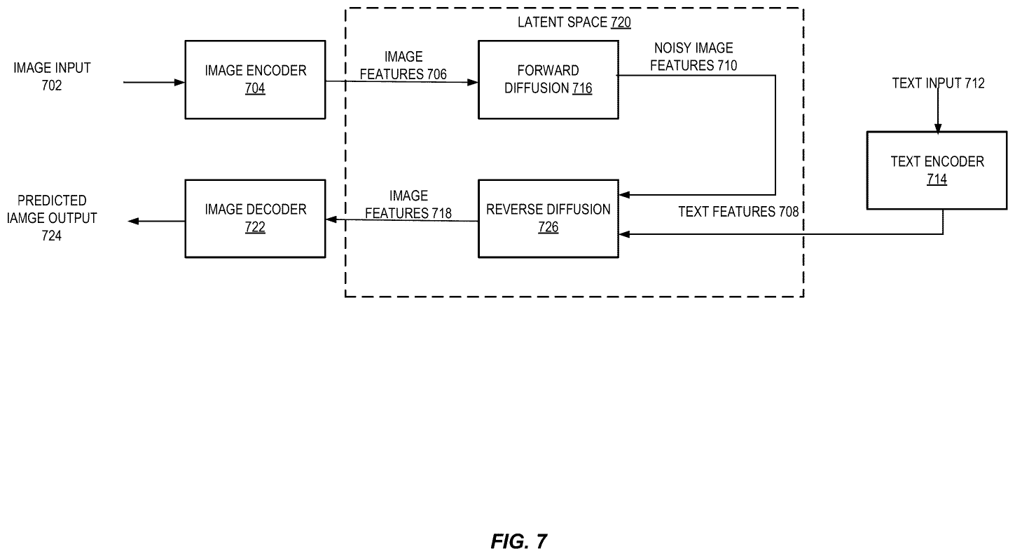

FIG. 7 illustrates an example implementation of a diffusion model, in accordance with one or more embodiments. As described herein, the generative AI can be performed using any suitable mechanism. In some embodiments, such generative AI is performed using a diffusion model.

A diffusion model is one example architecture used to perform generative AI. Generative AI involves predicting features for a given label. For example, given a label (or natural prompt description) “cat”, the generative AI module determines the most likely features associated with a “cat.” The features associated with a label are determined during training using a reverse diffusion process in which a noisy image is iteratively denoised to obtain an image. In operation, a function is determined that predicts the noise of latent space features associated with a label.

During training, an image (e.g., an image of a cat) and a corresponding label (e.g., “cat”) are used to teach the diffusion model features of a prompt (e.g., the label “cat”). As shown in FIG. 7, an input image 702 and a text input 712 are transformed into latent space 720 using an image encoder 704 and a text encoder 714 respectively. As a result, latent image features 706 and text features 708 are determined from the image input 702 and text input 712 accordingly. The latent space 720 is a space in which unobserved features are determined such that relationships and other dependencies of such features can be learned. In some embodiments, the image encoder 704 and/or text encoder 714 are pretrained. In other embodiments, the image encoder 704 and/or text encoder are trained jointly.

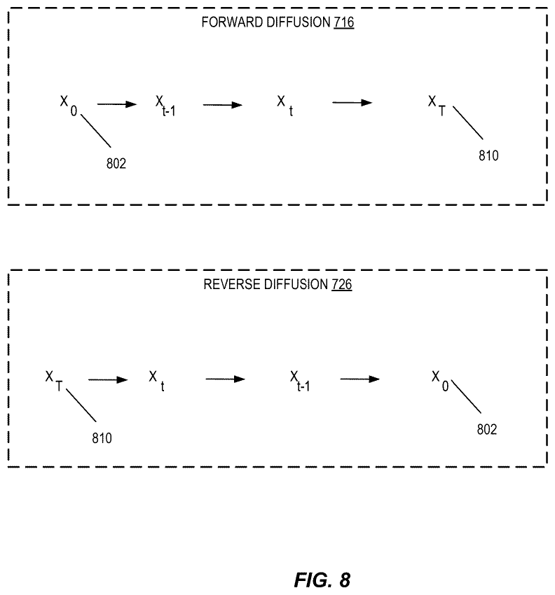

Once image features 706 have been determined by the image encoder 704, a forward diffusion process 716 is performed according to a fixed Markov chain to inject gaussian noise into the image features 706. The forward diffusion process 716 is described in more detail with reference to FIG. 8. As a result of the forward diffusion process 716, a set of noisy image features 710 are obtained.

The text features 708 and noisy image features 710 are algorithmically combined in one or more steps (e.g., iterations) of the reverse diffusion process 726. The reverse diffusion process 726 is described in more detail with reference to FIG. 8. As a result of performing reverse diffusion, image features 718 are determined, where such image features 718 should be similar to image features 706. The image features 718 are decoded using image decoder 722 to predict image output 724. Similarity between image features 706 and 718 may be determined in any way. In some embodiments, similarity between image input 702 and predicted image output 724 is determined in any way. The similarity between image features 706 and 718 and/or images 702 and 724 are used to adjust one or more parameters of the reverse diffusion process 726.

FIG. 8 illustrates the diffusion processes used to train the diffusion model, in accordance with one or more embodiments. The diffusion model may be implemented using any artificial intelligence/machine learning architecture in which the input dimensionality and the output dimensionality are the same. For example, the diffusion model may be implemented according to a u-net neural network architecture.

As described herein, a forward diffusion process adds noise over a series of steps (iterations t) according to a fixed Markov chain of diffusion. Subsequently, the reverse diffusion process removes noise to learn a reverse diffusion process to construct a desired image (based on the text input) from the noise. During deployment of the diffusion model, the reverse diffusion process is used in generative AI modules to generate images from input text. In some embodiments, an input image is not provided to the diffusion model.

The forward diffusion process 716 starts at an input (e.g., feature X₀ indicated by 802). Each time step t (or iteration) up to a number of T iterations, noise is added to the feature x such that feature x_{T} indicated by 810 is determined. As described herein, the features that are injected with noise are latent space features. If the noise injected at each step size is small, then the denoising performed during reverse diffusion process 726 may be accurate. The noise added to the feature X can be described as a Markov chain where the distribution of noise injected at each time step depends on the previous time step. That is, the forward diffusion process 716 can be represented mathematically q(x_{1:T}|x₀)=Πₜ₌₁^{T}q(xₜ|xₜ₋₁).

The reverse diffusion process 726 starts at a noisy input (e.g., noisy feature X_{T} indicated by 810). Each time step t, noise is removed from the features. The noise removed from the features can be described as a Markov chain where the noise removed at each time step is a product of noise removed between features at two iterations and a normal Gaussian noise distribution. That is, the reverse diffusion process 726 can be represented mathematically as a joint probability of a sequence of samples in the Markov chain, where the marginal probability is multiplied by the product of conditional probabilities of the noise added at each iteration in the Markov chain. In other words, the reverse diffusion process 726 is p_{θ}(x_{0:T})=p(xₜ)Πₜ₌₁^{T}p_{θ}(xₜ₋₁|xₜ), where p(xₜ)=N(xₜ;0,1).

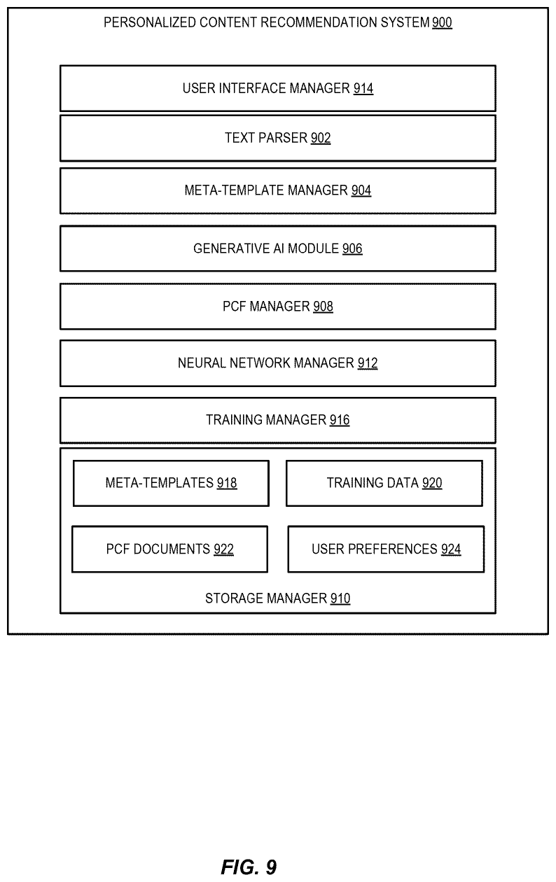

FIG. 9 illustrates a schematic diagram of personalized content recommendation system (e.g., “personalized content recommendation system” described above) in accordance with one or more embodiments. As shown, the personalized content recommendation system 900 may include, but is not limited to, a user interface manager 914, a text parser 902, a meta-template manager 904, a generative AI module 906, a PCF manager 908, a neural network manager 912, and a training manager 916. The storage manager 910 includes meta-template storage 918, training data 920, PCF documents 922, and user preferences 924.

The personalized content recommendation system 900 includes a user interface manager 914. The user interface manager 914 allows users to provide inputs (e.g., a title of content, a purpose of the content, a user intent, or some description of content to be generated, otherwise referred to herein as consumable content). Inputs also include refinements to the meta-template. For example, a user may refine a modification to a semantic block determined by the text parser 902, an addition of a one or more sub-prompts in the meta-template, a deletion of one or more sub-prompts in the meta-template, a modification of a sub-prompt in the meta-template, a modified intent (e.g., a new input), a modified control loop and/or constraint, an addition of a control loop and/or constraint, a removal of a control loop and/or constraint, and the like. Similarly, inputs may include profile information, where profile information may be any information specific to a customer or target user. For example, profile information may include a geographic location, a name, a favorite color, a career, a type of computing device, musical preferences, and the like.

As illustrated in FIG. 9, the personalized content recommendation system 900 includes a text parser 902. The text parser 902 parses or otherwise decomposes a user input into one or more personalization variables. Personalization variables are semantically related variables determined from the user input. For example, first the text parser 902 parses the input using any suitable one or more parsing techniques. Subsequently, the text parser 902 performs any suitable semantic searching/semantic relatedness technique to derive personalization variables from the parsed input. For example, geo-location, landmark, style, mood, personites, color, and the like, may all be semantic personalization variables derived from the input using any suitable semantic searching/semantic relatedness technique.

The personalization variables derived from the input using the text parser 902 are fed to the meta-template manager 904. The meta-template manager 904 organizes a template to be displayed to a user (a designer or other content producer). The template is a compilation of sub-prompts, which may be manually determined and/or automatically determined. A sub-prompt, as described herein, may include a free text description and one or more personalization variables derived from the input.

The meta-template manager 904 may query meta-template storage 918 of the storage manager 910 for a meta-template associated with a user (such as a designer). Meta-templates may vary, for example, by the sub-prompts associated with particular users, corporations, and the like. Moreover, meta-templates may vary depending on one or more control loops and/or constraints. Such control loops/constraints may refine the use of personalization variables in the meta-template. For example, a constraint may specific a particular subset of personalization variables for use in a particular meta-template.

The meta-template manager 904 may receive one or more user refinements (e.g., a user input received by the user interface manager 914). As described herein, a user refinement is a modification to a semantic block determined by the text parser, an addition of a one or more sub-prompts in the meta-template, a deletion of one or more sub-prompts in the meta-template, a modification of a sub-prompt in the meta-template, a modified intent (e.g., a new input), a modified control loop and/or constraint, an addition of a control loop and/or constraint, a removal of a control loop and/or constraint, and the like. Providing the user access to the personalization variables refines the composite of images generated from the sub-prompts. For instance, a user may choose between colors or moods that have been extracted for insertion into the sub-prompt. Additionally or alternatively, a user may further define semantic and/or design rules in the prompt domain specific language to configure contrasting colors, make decisions about specific conditions in the personalization variables, and the like.

The meta-template manager 904 may also receive profile information (e.g., a user input received by the user interface manager 914). As described herein, profile information is any information specific to a consumer or target user. For example, profile information may include a geographic location, a name, a favorite color, a career, a type of computing device, musical preferences, and the like. Given profile information, the meta-template manager 904 incorporates consumer information into sub-prompts. The more information provided to the generative AI module 906 (in the form of a prompt based on the meta-template sub-prompts), the more personalized and specific the generated content produced by the generative AI module will be. In this manner, personalized content corresponding to an intent of a user (a designer) with respect to a specific consumer (based on profile information) is generated.

As illustrated in FIG. 9, the personalized content recommendation system 900 also includes a generative AI module 906. It should be appreciated that multiple generative AI modules 906 may be executed by the personalized content recommendation system 900. The generative AI module 906 generates content (e.g., an image) to be consumed by a consumer (or a target user). The generative AI module 906 may be any generative AI module configured to generate content using a prompt. As described herein, the prompt is the meta-template including multiple sub-prompts and corresponding personalized variables.

As illustrated in FIG. 9, the personalized recommendation system 900 also includes a PCF manager 908. The PCF manager 908 groups extracted one or more of the input, the extracted personalization variables (e.g., from the template parser 902), refined personalized variables (e.g., received from refinements), generated sub-prompts in the meta-template, refined sub-prompts in the meta-template (e.g., received from refinements), control loops, rules, and an output of the generative AI module 906. Such information is persisted in a PCF document. In some embodiments, additional information is persisted in the PCF such as the generative AI module 906, one or more algorithms/techniques to adapt to any signal like text, language, product insertion or artistic change, and the like. Additionally or alternatively, information such as profile information associated with a particular consumer consuming content, and/or user preferences (such as content creator preferences) are aggregated by the PCF manager 908 and persisted in a PCF document. By storing such data, the PCF preserves the original design or commercial intent.

As illustrated in FIG. 9, the personalized content recommendation system 900 also includes a neural network manager 912. Neural network manager 912 may host a plurality of neural networks or other machine learning models, such as generative AI module 906. The neural network manager 912 may include an execution environment, libraries, and/or any other data needed to execute the machine learning models. In some embodiments, the neural network manager 912 may be associated with dedicated software and/or hardware resources to execute the machine learning models. As discussed, generative AI module 906 can be implemented as any type of generative AI. In various embodiments, each neural network hosted by neural network manager 912 may be the same type of neural network or may be different types of neural network, depending on implementation. Although depicted in FIG. 9 as being hosted by a single neural network manager 912, in various embodiments the neural networks may be hosted in multiple neural network managers and/or as part of different components. For example, generative AI module 906 can be hosted by its own neural network manager, or other host environment, in which the respective neural networks execute, or the generative AI module 906 may be spread across multiple neural network managers depending on, e.g., the resource requirements of the generative AI module 906, etc.

As illustrated in FIG. 9 the personalized content recommendation system 900 also includes training manager 916. The training manager 916 can teach, guide, tune, and/or train one or more neural networks. In particular, the training manager 916 can train a neural network based on a plurality of training data. For example, the generative AI module 906 may be trained to perform the reverse diffusion process. More specifically, the training manager 916 can access, identify, generate, create, and/or determine training inputs and utilize the training inputs to train and fine-tune a neural network.

As illustrated in FIG. 9, the personalized content recommendation system 900 also includes the storage manager 910. The storage manager 910 maintains data for the personalized content recommendation system 900. The storage manager 910 can maintain data of any type, size, or kind as necessary to perform the functions of the personalized content recommendation system 900. The storage manager 910, as shown in FIG. 9, includes the meta-templates 918. Meta-templates 918 are templates including a compilation of sub-prompts, which may be manually determined and/or automatically determined. A sub-prompt, as described herein, may include a free text description and one or more personalization variables derived from the input. Additionally or alternatively, the sub-prompt may be a portion of the input. Meta-templates associated with a user (such as a designer) may include user preferences, sub-prompt preferences, corporation preferences (e.g., an employer corporation employing a user designer), control loops, constraints, and the like. Control loops/constraints may refine the use of personalization variables in the meta-template. The storage manager 910 also stores a record of historic inputs such as user preferences 924. Training data 920 is also stored in the storage manager 910. Training data 920 includes manually labeled data for supervised learning. Training using supervised learning is part of the training performed during semi-supervised learning. Lastly, the storage manager 910 stores PCF documents 922 generated using the PCF manager 908. As described herein, PCF documents include one or more of the input, the extracted personalization variables (e.g., from the template parser 902), refined personalized variables (e.g., received from refinements), generated sub-prompts in the meta-template, refined sub-prompts in the meta-template (e.g., received from refinements), control loops, rules, and content determined by the generative AI module 906.

Each of the components 902-916 of the personalized content recommendation system 900 and their corresponding elements (as shown in FIG. 9) may be in communication with one another using any suitable communication technologies. It will be recognized that although components 902-916 and their corresponding elements are shown to be separate in FIG. 9, any of components 902-916 and their corresponding elements may be combined into fewer components, such as into a single facility or module, divided into more components, or configured into different components as may serve a particular embodiment.

The components 902-916 and their corresponding elements can comprise software, hardware, or both. For example, the components 902-916 and their corresponding elements can comprise one or more instructions stored on a computer-readable storage medium and executable by processors of one or more computing devices. When executed by the one or more processors, the computer-executable instructions of the personalized content recommendation system 900 can cause a client device and/or a server device to perform the methods described herein. Alternatively, the components 902-916 and their corresponding elements can comprise hardware, such as a special purpose processing device to perform a certain function or group of functions. Additionally, the components 902-916 and their corresponding elements can comprise a combination of computer-executable instructions and hardware.

Furthermore, the components 902-916 of the personalized content recommendation system 900 may, for example, be implemented as one or more stand-alone applications, as one or more modules of an application, as one or more plug-ins, as one or more library functions or functions that may be called by other applications, and/or as a cloud-computing model. Thus, the components 902-916 of the personalized content recommendation system 900 may be implemented as a stand-alone application, such as a desktop or mobile application. Furthermore, the components 902-916 of the personalized content recommendation system 900 may be implemented as one or more web-based applications hosted on a remote server. Alternatively, or additionally, the components 902-916 of the personalized content recommendation system 900 may be implemented in a suite of mobile device applications or “apps.”

As shown, the personalized content recommendation system 900 can be implemented as a single system. In other embodiments, the personalized content recommendation system 900 can be implemented across multiple systems. For example, one or more functions of the personalized content recommendation system 900 can be performed by one or more servers, and one or more functions of the personalized content recommendation system 900 can be performed by one or more client devices.

For example, upon the client device accessing a webpage or other web application hosted at the one or more servers, in one or more embodiments, the one or more servers can provide access to a user interface displayed at a client device prompting a user for a description of consumable content. The client device can provide the description of the consumable content to the one or more servers. Upon receiving the description, the one or more servers can automatically perform the methods and processes described above to identify semantically related terms based on the description of the consumable content and populate a template with user preferences, consumer information, semantically related terms, controls, and the like. The one or more servers can provide access to the user interface displayed at the client device with the populated template. The client device can be used to receive user inputs modifying one or more entries of a sub-prompt of the template, thereby refining the template. Upon receiving the modifications (or upon receiving a request to execute content generation), the one or more servers automatically perform the methods and processes described above to generate personalized content for the target audience based on the description of consumable content.

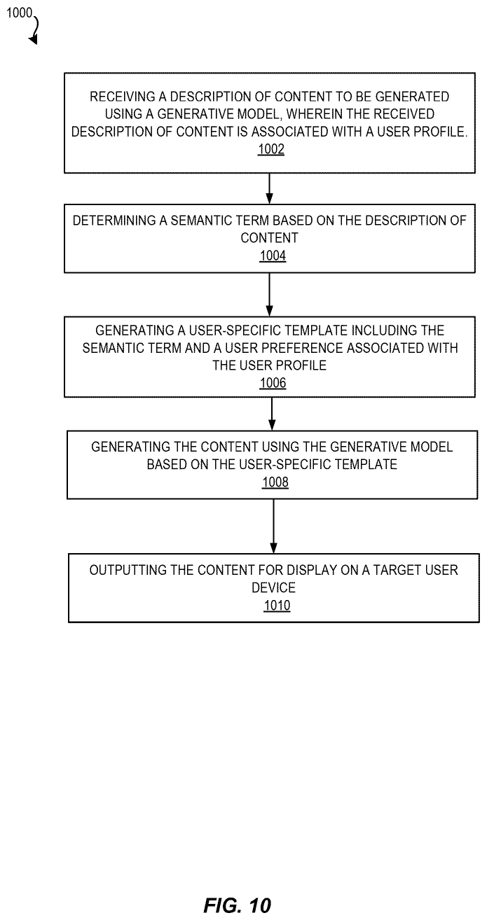

FIGS. 1-9, the corresponding text, and the examples, provide a number of different systems and devices that allows a user to produce personalized content for a target audience in accordance with one or more embodiments. In addition to the foregoing, embodiments can also be described in terms of flowcharts comprising acts and steps in a method for accomplishing a particular result. For example, FIG. 10 illustrates a flowchart of an exemplary method in accordance with one or more embodiments. The method described in relation to FIG. 10 may be performed with fewer or more steps/acts or the steps/acts may be performed in differing orders. Additionally, the steps/acts described herein may be repeated or performed in parallel with one another or in parallel with different instances of the same or similar steps/acts.

FIG. 10 illustrates a flowchart 1000 of a series of acts in a method of producing personalized content for a target audience in accordance with one or more embodiments. In one or more embodiments, the method 1000 is performed in a digital medium environment that includes the personalized content recommendation system 900. The method 1000 is intended to be illustrative of one or more methods in accordance with the present disclosure and is not intended to limit potential embodiments. Alternative embodiments can include additional, fewer, or different steps than those articulated in FIG. 10.

As illustrated in FIG. 10, the method 1000 includes an act 1002 of receiving a description of content to be generated using a generative model, wherein the received description of content is associated with a user profile. As described herein, a description of content may include a title of content, a purpose of content, a user intent, or some other description of content to be generated. As described herein, the description of content may be appended with user identification information such that the user identification information associated with the description of content can be mapped to a user profile. In some embodiments, depending on the determined user profile, different personalization variables are extracted from the description of content.

The method 1000 includes an act 1004 of determining a semantic term based on the description of content. As described herein, the description of consumable content is decomposed into personalization variables using any suitable semantic searching/semantic relevance algorithm, where personalization variables are semantically related blocks determined from the description of consumable content. A semantic block is a semantically related phrase, term, and the like.

The method 1000 includes an act 1006 of generating a user-specific template including the semantic term and a user preference associated with the user profile. As described herein, a template is a compilation of sub-prompts, which may include a free text description and one or more personalization variables derived from the description of consumable content. One or more personalization variables may be auto-populated into the template. As described herein, a meta-template associated with a user profile may be determined responsive to an identifier associated with the user. An identifier such as a user number, user name, email address, phone number, etc. may be appended to the description of content, associated with the description of content, in metadata, and the like. Meta-templates may vary, for example, by the sub-prompts associated with user profiles identified via the user profile. Moreover, meta-templates may vary depending on one or more control loops and/or constraints. Such control loops/constraints may refine the use of personalization variables in the meta-template.

The method 1000 includes an act 1008 generating the content using the generative model based on the user-specific template. As described herein, the user-specific template populated with personalization variables and corresponding sub-prompts (e.g., the meta-template) is fed into one or more generative AI modules. The generative AI module generates content (e.g., an image) to be consumed by a consumer (or a target user). The generative AI module may be any generative AI module configured to generate content using a prompt.

The method 1000 includes an act 1010 of outputting the content for display on a target user device. As described herein, the personalized content may be communicated to one or more computing devices.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

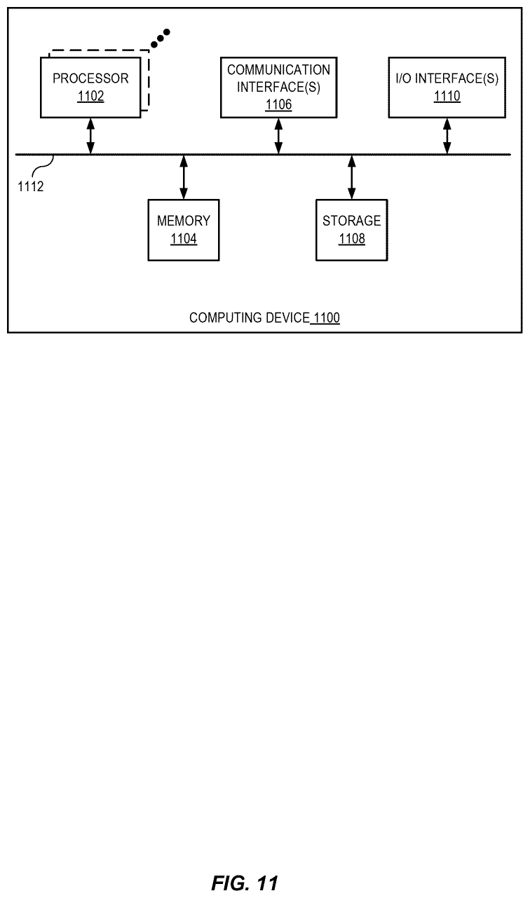

FIG. 11 illustrates, in block diagram form, an exemplary computing device 1100 that may be configured to perform one or more of the processes described above. One will appreciate that one or more computing devices such as the computing device 1100 may implement the personalized content recommendation system. As shown by FIG. 11, the computing device can comprise a processor 1102, memory 1104, one or more communication interfaces 1106, a storage device 1108, and one or more I/O devices/interfaces 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1108 and decode and execute them. In various embodiments, the processor(s) 1102 may include one or more central processing units (CPUs), graphics processing units (GPUs), field programmable gate arrays (FPGAs), systems on chip (SoC), or other processor(s) or combinations of processors.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1104 may be internal or distributed memory.

The computing device 1100 can further include one or more communication interfaces 1106. A communication interface 1106 can include hardware, software, or both. The communication interface 1106 can provide one or more interfaces for communication (such as, for example, packet-based communication) between the computing device and one or more other computing devices 1100 or one or more networks. As an example and not by way of limitation, communication interface 1106 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can comprise hardware, software, or both that couples components of computing device 1100 to each other.

The computing device 1100 includes a storage device 1108 includes storage for storing data or instructions. As an example, and not by way of limitation, storage device 1108 can comprise a non-transitory storage medium described above. The storage device 1108 may include a hard disk drive (HDD), flash memory, a Universal Serial Bus (USB) drive or a combination these or other storage devices. The computing device 1100 also includes one or more input or output (“I/O”) devices/interfaces 1110, which are provided to allow a user to provide input to (such as user strokes), receive output from, and otherwise transfer data to and from the computing device 1100. These I/O devices/interfaces 1110 may include a mouse, keypad or a keyboard, a touch screen, camera, optical scanner, network interface, modem, other known I/O devices or a combination of such I/O devices/interfaces 1110. The touch screen may be activated with a stylus or a finger.

The I/O devices/interfaces 1110 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1110 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a description of content to be generated using a generative model, wherein the received description of content is associated with a user profile;
determining a semantic term based on the description of content;
generating a user-specific template including the semantic term and a user preference associated with the user profile;
generating the content using the generative model based on the user-specific template; and
outputting the content for display on a target user device.

2. The method of claim 1, further comprising:
receiving a user refinement modifying the semantic term of the user-specific template, wherein the user refinement is at least one of a modification of the semantic term, an addition of one or more semantic terms, a deletion of one or more semantic terms, a modification of the description of content, a modification of a control loop, or a modification of a constraint; and
generating the content using the generative model based on a modified user-specific template including the user refinement.

3. The method of claim 1, further comprising:
obtaining target profile information, wherein the target profile information is information specific to a target user; and
generating the content using the generative model is further based on the target profile information.

4. The method of claim 3, wherein the target profile information is obtained by querying a database or a user input.

5. The method of claim 1, wherein generating the content using the generative model is further based on profile information of users similar to a target user.

6. The method of claim 1, further comprising:
obtaining a semantically related image from the generated content.

7. The method of claim 6, further comprising:
outputting the semantically related image for display on the target user device.

8. A system comprising:
a memory component; and
a processing device coupled to the memory component, the processing device to perform operations comprising:
receiving a description of content to be generated using a generative model, wherein the received description of content is associated with a user profile;
determining a semantic term based on the description of content;
generating a user-specific template including the semantic term and a user preference associated with the user profile;
generating content using a generative model based on the user-specific template; and
outputting the content for display on a target user device.

9. The system of claim 8, wherein the processing device performs further operations comprising:
receiving a user refinement modifying the semantic term of the user-specific template, wherein the user refinement is at least one of a modification semantic term, an addition of one or more semantic terms, a deletion of one or more semantic terms, a modification of the description of content, a modification of a control loop, or a modification of a constraint; and
generating the content using the generative model based on a modified user-specific template including the user refinement.

10. The system of claim 8, wherein the processing device performs further operations comprising:
obtaining target profile information, wherein the target profile information is information specific to a target user; and
generating the content using the generative model is further based on the target profile information.

11. The system of claim 10, wherein the target profile information is obtained by querying a database or a user input.

12. The system of claim 8, wherein generating the content using the generative model is further based on profile information of users similar to a target user.

13. The system of claim 8, wherein the processing device performs further operations comprising:
obtaining a semantically related image from the generated content.

14. The system of claim 13, wherein the processing device performs further operations comprising:
outputting the semantically related image for display on the target user device.

15. A non-transitory computer-readable medium storing executable instructions, which when executed by a processing device, cause the processing device to perform operations comprising:
during a first period of time, creating a file including a template populated with a semantic term determined based on a description of content;
receiving the file during a second period of time;
generating content using a generative model based on the template of the file; and
outputting the content.

16. The non-transitory computer-readable medium of claim 15, wherein the template of the file further includes a sub-prompt associated with a user preference.

17. The non-transitory computer-readable medium of claim 15, wherein the template of the file further includes a sub-prompt associated with a preference of a group of users similar to a user.

18. The non-transitory computer-readable medium of claim 15, wherein the template of the file further includes information specific to a target user.

19. The non-transitory computer-readable medium of claim 15, storing instructions that further cause the processing device to perform operations comprising:
receiving a user refinement associated with the semantic term during the second period of time; and
generating content using the generative model based on the template in the file and further based on the user refinement.

20. The non-transitory computer-readable medium of claim 19, storing instructions that further cause the processing device to perform operations comprising:
updating the template to include the received user refinement during the second period of time.
